(19) United States
(12) Patent Application Publication
(10) Pub. No.: US 2007/0253102 A1
(43) Pub. Date: Nov. 1, 2007

(54) Disc Clamp Having Laser Reflectivity

(75) Inventor: Mohamed Dulfakir Abdul Hameed, Singapore (SG)

Correspondence Address: SEAGATE TECHNOLOGY LLC C/O WESTMAN;CHAMPLIN & KELLY, P.A., SUITE 1400, 900 SECOND AVENUE SOUTH, MINNEAPOLIS, MN, 55402-3319, US

(73) Assignee: MAXTOR CORPORATION, Scotts Valley, CA (US)

(21) Appl. No.: 11/739,306

(22) Filed: Apr. 24, 2007

Related U.S. Application Data
(60) Provisional application No. 60/746,073, filed on May 1, 2006.

(51) Int. Cl. G11B 17/02

(52) U.S. Cl. 360/99.08; 360/99.12

(57) ABSTRACT

A component in a manufacturing process is provided. The manufacturing process makes use of laser position sensing devices to determine a position of components being manufactured. The component includes a body having an exterior surface including a plurality of angled surfaces. The component also includes a surface roughness formed on one of the plurality of angled surfaces of the exterior surface.

### CROSS REFERENCE TO RELATED APPLICATIONS

This application claims the benefit of U.S. Provisional Application 60/746,073 filed on May 1, 2006 entitled “DISK DRIVE CLAMP WITH IMPROVED LASER REFLECTIVITY,” the entire disclosure of which is hereby incorporated by reference in its entirety.

### BACKGROUND

Data storage systems often utilize rotary actuators to position one or more read/write transducers with one or more storage media rotatably mounted on a hub driven by a motor. The read/write transducers access data as they move along particular tracks of the storage media to read information recorded on that track and/or to write information to a particular location on the disk.

Often times, data storage systems contains storage media in the form of data storage discs. A data storage system can have one or multiple data storage disc(s). Multiple data storage discs can be assembled in a disc pack. A corresponding number of rotary actuators are then used to read and write data to and from the discs. A disc clamp is used to secure the disc or the disc pack to a spindle hub. During the assembly of the data storage system, the disc clamp is secured to the hub thereby securely fastening the disc or disc pack to the hub.

In an automated assembly process, it might be necessary to first balance the disc clamp before the disc clamp is placed over the spindle hub for securing the disc or the disc pack. Since the hub rotates at a high speed, any characteristics of the clamp that cause it to be unbalanced can negatively affect data storage system performance. Therefore, prior to assembly of the disc clamp over the spindle hub, the disc clamp is placed in a balancing station. In the balancing station, the disc clamp is balanced by mounting a balance ring to the upper surface of the disc clamp. In a balancing station incorporated within an automated production line, a laser beam can be directed on the surface of the disc clamp. The surface of the disc clamp reflects the laser beam, which is then received by a laser sensor used to determine the position of the disc clamp. If the disc clamp is misaligned, the disc clamp is then moved so that the disc clamp is in the correct position to receive the balance ring.

The surface of a disc clamp can be generally characterized as being smooth. Therefore, when the laser strikes the smooth surface of the disc clamp at the balancer station, the reflected beam is a concentrated beam of light. Therefore, the direction of the reflected laser beam is highly dependent upon the angle at which the laser beam strikes the clamp. If there is a sufficient change in the incident angle at which the beam strikes the disc clamp, the laser sensor might not be able to detect the reflected laser beam. For example, if there is any slight misalignment of the tooling in the automated production line which holds the disc clamp for processing, the laser sensor might not be able to detect the position of the disc clamp because either the reflected beam will not be sensed at all by the sensor, or the lower intensity of the reflected beam striking the laser sensor does not allow the sensor to correctly confirm the clamp position. The clamp itself may not be misaligned, but just the tooling such that if the clamp could be located by the laser position sensing device, the clamp could be processed. If the laser sensor is not able to determine the position of the disc clamp, further processing of the disc clamp cannot be achieved, and the automated production line must be shut down or otherwise delayed until the clamp can be located by the sensor.

Therefore, there is a need to improve sensing of components in automated production lines even when there is a slight misalignment of the tooling which holds and transfers the components from one station to another.

### SUMMARY

A component in a manufacturing process is provided. The manufacturing process makes use of laser position sensing devices to determine a position of components being manufactured. The component includes a body having an exterior surface including a plurality of angled surfaces. The component also includes a surface roughness formed on one of the plurality of angled surfaces of the exterior surface.

A method for detecting a position of a component is also provided. A component is provided that has an exterior surface that includes a surface roughness in a general location where an incident beam of a laser sensing apparatus will strike the component. The incident beam is directed from the laser position sensing apparatus to strike the component at the general location. A reflected beam is dispersed in a reflected pattern that is larger in size than a pattern of the incident beam striking the component. The reflected beam is detected by a sensor on the laser position sensing device.

These and various other features and advantages will be apparent from a reading of the following Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 illustrates a plan view of a data storage system with a top cover removed.

FIG. 2 is one type of a disk clamp that needs to be balanced prior to installation over a spindle hub.

FIG. 3 is a schematic diagram illustrating a partial sectional view of the disc clamp of FIG. 2 and a laser position sensing device used to detect a position of the disc clamp.

FIG. 4 illustrates an enlarged portion of a disc clamp under one embodiment.

FIG. 5 is schematic diagram illustrating a partial sectional view of the disc clamp of FIG. 4 and a laser position sensing device used to detect a position of the disc clamp.

### DETAILED DESCRIPTION

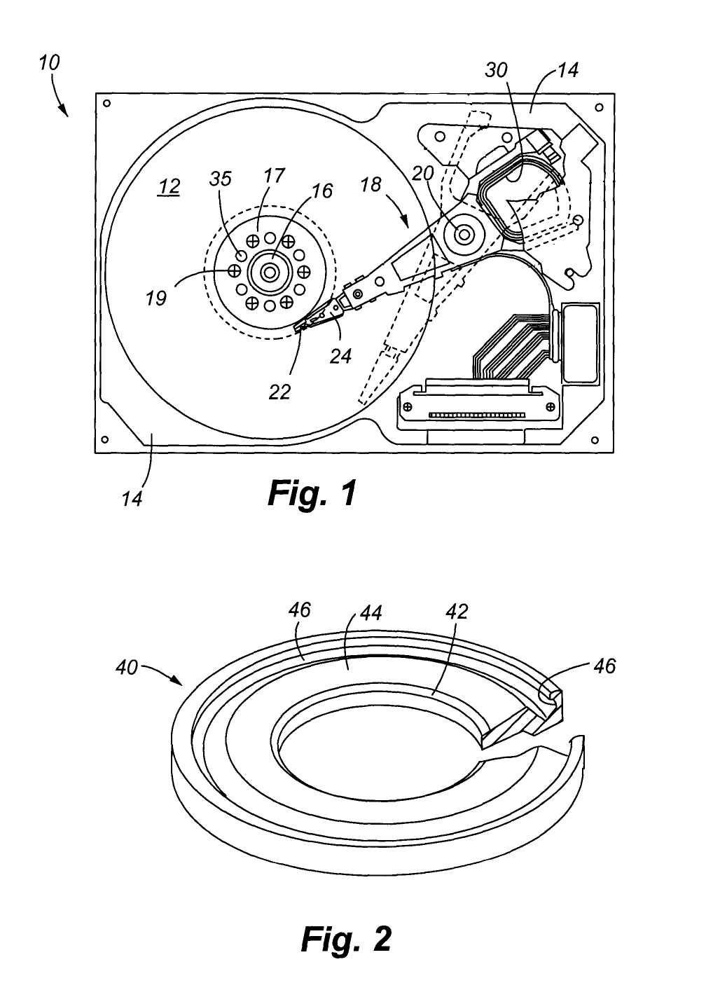

FIG. 1 illustrates a plan view of a data storage system 10 with a top cover removed to show its basic components. Embodiments of the disclosure are configured for use with data storage system 10 illustrated in FIG. 1. Data storage system 10 includes at least one storage medium or disc 12. The storage medium or disc 12, along with other components of data storage system 10, are contained within a housing 14. The storage medium or disc 12 is mounted over a spindle hub 16 that is driven by a motor (not shown). The motor enables the storage medium or disc 12 to rotate at a high speed during operation. It should be understood that storage medium or disc 12 can be just one or a plurality of discs assembled in a disc pack mounted over the spindle hub 16.

A disc clamp 17 secures the disc(s) to the spindle hub by a plurality of screws 19 that are received in threaded openings on an upper surface of hub 16. When disc clamp 17 utilizes screws to secure the clamp to the spindle hub 16, a plurality of balancing openings 35 can form in the disc clamp, and balancing material can be placed within openings 35 to balance the overall assembly of the disc(s) 12 as secured to spindle hub 16. An actuator assembly 18 is rotatably mounted to an actuator pivot 20. Actuator assembly 18 includes one or more read/write heads 22 mounted on a flexure or suspension 24. Actuator assembly 18 can be rotated to a desired disc track by a voice coil motor 30. The dotted position of the actuator assembly 18 illustrates the manner in which the actuator assembly rotates about actuator pivot 20 in response to the voice coil motor 30.

FIG. 2 illustrates another type of disc clamp 40, namely, a screwless disc clamp that is secured to a spindle hub in a different manner. Specifically, the disc clamp 40 shown in FIG. 2 includes an angled surface 42 which can be positioned directly adjacent an undercut formed in a portion of a spindle hub, such as spindle hub 16 of FIG. 1. A retaining member (not shown) is placed between the angled surface 42 and the undercut on the spindle hub in order to keep disc clamp 40 in place. In FIG. 2, disc clamp 40 includes an annular body 44 and an upper peripheral groove 46. Upper peripheral groove 46 is especially adapted to receive a balance ring (not shown). In general, a balance ring includes two opposing ends having an intervening gap between the opposing ends. The balance ring presses outwardly against the groove 46 and is held in place by the groove 46. A balance ring is used to balance the weight of a disc assembly or a disc pack assembly by shifting a center of mass of the disc assembly or disc pack assembly closer to its center of rotation. To shift the weight of the disc assembly or the disc pack assembly, a certain balance ring is selected with a certain gap size that corresponds with a magnitude of displacement of the center of mass that is needed to align with the center of rotation.

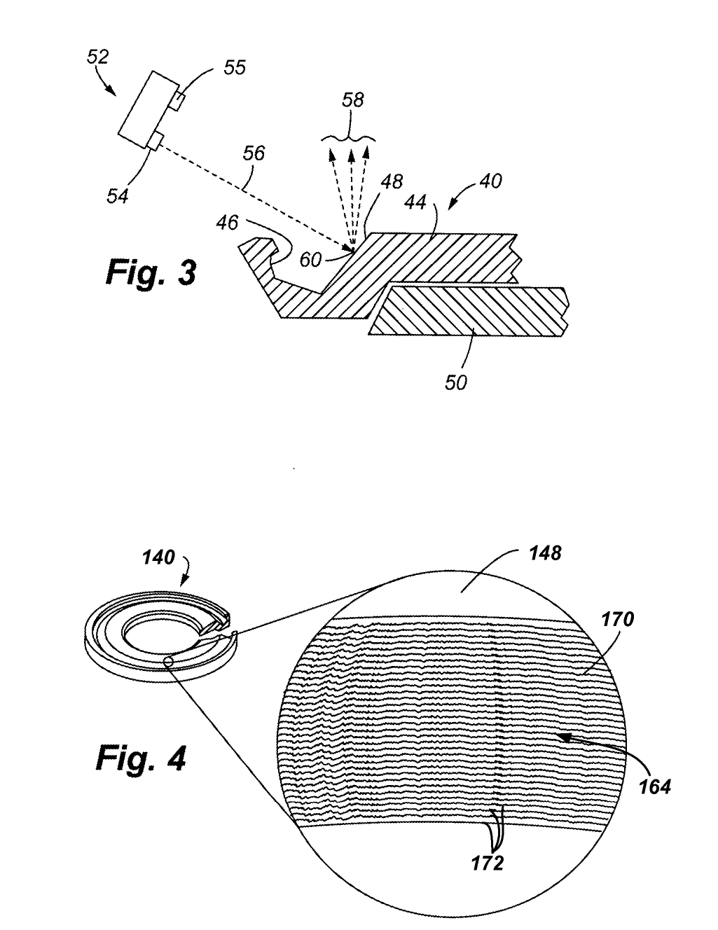

FIG. 3 is a schematic diagram of disk clamp 40 of FIG. 2 as is illustrated as a partial sectional view in an automated processing or production line where the disc clamp is, for example, to be balanced, reworked, or otherwise processed. Disc clamp 40 includes an annular body 44 and groove 46. Disc clamp 40 can be secured by some type of tooling in an automated processing or production line, such as a carrier 50. At the particular station in which disc clamp 40 is being handled, a laser position sensing device 52 can be used to detect the position of the disc clamp. In the schematic diagram of FIG. 3, the laser position sensing device 52 includes a laser emitter 54 that generates a laser beam 56 configured to strike an angled surface 48 of disc clamp 40 at point 60. Such an incident beam 56 strikes the point 60, and the reflected beam 58 is shown as having somewhat of a dispersed pattern. However, the dispersion of reflected beam 58 is not great enough to allow the reflected beam to be detected by laser sensor 55. In such a case, a position of disc clamp 40 cannot be ascertained in the production line for the mounting of a balance ring.

Accordingly, the production line is interrupted until a position of disc clamp 40 is changed so that the reflected angle of reflected beam 58 strikes sensor 55. In the alternative, the production line is interrupted until incident beam 56 of the detection device 52 is adjusted so that reflected beam 58 strikes sensor 55. If a position of the disc clamp is to be changed, the tooling must be adjusted. Both production interrupts and tool adjustments delay production. Delayed production is undesirable and has many adverse consequences for production efficiency and cost.

FIG. 4 illustrates an enlarged portion of an angled surface 148 of a disc clamp 140 under one embodiment. To better disperse a reflected beam, such as reflected beam 58 of FIG. 3, so that a sensor, such as sensor 55, can ascertain a position of disc clamp 140, angled surface 148 that receives an incident beam, such as incident beam 56 of FIG. 3, includes a surface roughness 164. Surface roughness 164 can be formed on angled surface 148 in a variety of ways including forming machine marks 170, as illustrated. As shown in FIG. 4, angled surface 148 includes machine marks 170 illustrated as a plurality of grooves 172 spaced apart from one another. In one embodiment, each of the plurality of grooves 172 are spaced apart from each other between about 50 and 100 microns.

Grooves 172 can be formed in one embodiment by stamping angled surface 148 with a stamping element that dictates the particular length, width, position and spacing of the grooves. In another embodiment, angled surface 148 can be scored or roughened. Once the surface roughness 164 of the disc clamp 140 has been formed, angled surface 148 can be cleaned or polished as necessary to remove the bulk of particulate matter that may be created by the stamping, scoring or roughening.

Although FIG. 4 illustrates grooves 172 as being substantially equally spaced from one another and extending linearly in a substantially parallel orientation, it shall be understood that the particular pattern in which the machine marks 170 are provided can be in other configurations to include irregular spaced grooves, non-linear grooves, as well as grooves having different sizes. One advantage to providing substantially uniform configured grooves is that the dispersion pattern of the reflected beam created by the grooves is a very wide and evenly dispersed pattern of light, thereby greatly increasing the likelihood that the reflected beam will be sufficiently dispersed yet of adequate intensity so that sensor 60, such as sensor 55 of FIG. 3, can detect the reflected beam. In addition, grooves 172 can be positioned linearly, but oriented in a direction perpendicular from the orientation shown in FIG. 4. Grooves 172 can also be positioned substantially perpendicular from each other to form a crisscross pattern

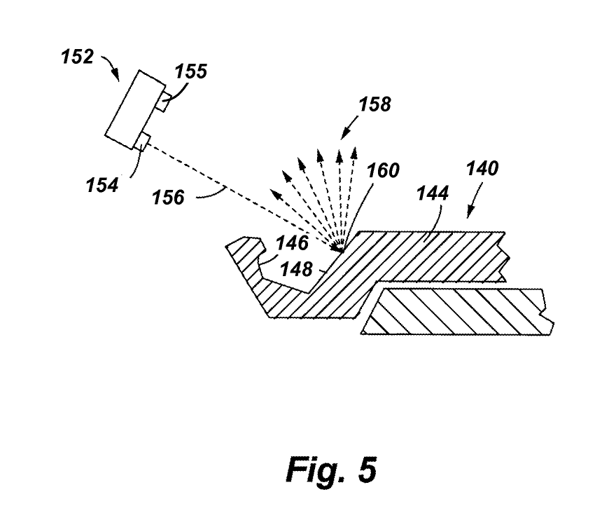

Referring to FIG. 5, a schematic diagram is illustrated showing the effect of surface roughness 170 (FIG. 4) on angled surface 148 of disc clamp 140. Disc clamp 140 includes annular body 144 and groove 146. As shown, reflected beam 158 is dispersed in a much wider pattern, thereby enabling a sensor 155 to detect the reflected beam 158 and therefore, determine the position of the disk clamp 140. Depending upon the angle of incident light beam 156 from laser emitter 154, the orientation of the angled surface 148 receiving beam 156, the frequency and intensity of the incident beam 156 at point 160, the distance of the sensing device 152 from the disk clamp 140, as well as the type of material used in the disk clamp 140, the location and pattern or type of grooves 172 (FIG. 4) used can be adapted to best ensure that the sensor 155 is able to detect the reflected beam 158.

In addition to providing groves on a disc clamp, it is also contemplated that grooves can be provided on other components of a data storage system such that that various other laser sensing devices can more easily sense a position of data storage system components as they are being manufactured and assembled. For example, in the assembly of a data storage system, it can also be advantageous to provide grooves on other components such as a data storage housing including a top cover as they are manipulated in the assembly process. Particularly for any angled surfaces of a housing, laser sensing devices could fail to consistently detect a position.

It is to be understood that even though numerous characteristics and advantages of various embodiments of the disclosure have been set forth in the foregoing description, this disclosure is illustrative only, and changes may be made in detail, especially in matters of structure and arrangement of parts within the principles of the disclosure to the full extent indicated by the broad general meaning of the terms in which the appended claims are expressed. For example, the particular elements may vary depending on the particular application of the disc clamp while maintaining substantially the same functionality without departing from the scope and spirit of the disclosure. In addition, although the embodiments described herein are directed to a disc clamp of a data storage system, it will be appreciated by those skilled in the art that the teachings of the disclosure can be applied to other types of components in a data storage system, without departing from the scope and spirit of the disclosure.

What is claimed is:

1. A component in a manufacturing process, the component comprising:
a body having an exterior surface including a plurality of angled surfaces; and
a surface roughness formed on one of the plurality of angled surfaces of the exterior surface.

2. The component of claim 1, wherein:
the surface roughness comprises a plurality of spaced apart grooves formed on the one of the plurality of angled surfaces.

3. The component of claim 2, wherein:
each of the plurality of grooves extend substantially linearly and substantially parallel to one another.

4. The component of claim 2, wherein:
each of the plurality of grooves are spaced from one another between about 50 to 100 microns.

5. The component of claim 1, wherein:
the surface roughness formed on one of the plurality of angled surface is formed by stamping the one of the plurality of angled surfaces.

6. The component of claim 1, wherein:
the body forms a disc clamp.

7. A disc clamp comprising:
an annular body having an exterior surface including a plurality of angled surfaces and a central opening; and
means for dispersing incident light placed on a selected portion of the exterior surface.

8. The disc clamp of claim 7, wherein:
the means for dispersing incident light comprise a plurality of grooves formed on the exterior surface.

9. The disc clamp of claim 8, wherein:
each of the plurality grooves extend substantially linearly and are oriented substantially parallel to one another.

10. The disc clamp of claim 8, wherein:
each of the plurality grooves are spaced from one another between about 50 to 100 microns.

11. The disc clamp of claim 8, wherein:
each of the plurality of grooves are formed by stamping the exterior surface.

12. The disk clamp of claim 8, wherein:
the grooves are formed on an angled surface of a channel formed on an upper surface of the disk clamp.

13. The disc clam of claim 7, wherein:
the means for dispersing incident light are provided in a pattern including machine marks.

14. A method of detecting a position of components in a manufacturing process, the method comprising:
providing a component having an exterior surface including a surface roughness in a general location where an incident beam of a laser sensing apparatus will strike the component;
directing a laser beam from the laser position sensing apparatus to strike the component at the general location;
dispersing a reflected beam in a reflected pattern that is larger in size than a pattern of the incident beam striking the component; and
detecting the reflected beam by a sensor on the laser position sensing device.

15. The method of claim 14, wherein:
the surface roughness includes a plurality of grooves formed on the exterior surface of the component.

16. The method of claim 15 wherein:
each of the plurality of grooves extend substantially linearly and are oriented substantially parallel to one another.

17. The method of claim 15, wherein:
the plurality of grooves are formed by stamping.

18. The method of claim 14, wherein:
the component comprises a disc clamp.

19. The method of claim 14, wherein:
the exterior surface comprises an angled surface.

20. The method of claim 19, wherein:
the angled surface comprises a plurality of grooves.
